(19) United States
(12) Patent Application Publication
(10) Pub. No.: US 2012/0246645 A1
(43) Pub. Date: Sep. 27, 2012

(54) METHOD FOR MANAGING VIRTUAL MACHINE, INFORMATION PROCESSING APPARATUS, AND MEDIUM FOR VIRTUAL MACHINE MANAGEMENT PROGRAM

(75) Inventors: Fumi IIKURA, Shinagawa (JP); Yasuhide MATSUMOTO, Kawasaki (JP)

(73) Assignee: FUJITSU LIMITED, Kawasaki-shi (JP)

(21) Appl. No.: 13/414,074

(22) Filed: Mar. 7, 2012

(30) Foreign Application Priority Data
Mar. 25, 2011 (JP) 2011-067484

(51) Int. Cl. G06F 9/455

(52) U.S. Cl. 718/1

(57) ABSTRACT

A method of managing a virtual machine by an information processing system including one or more information processing apparatuses, the method includes: comparing one or more files used for operation of the virtual machine with one or more template files; and generating configuration information indicating a setting state of the virtual machine based on a result of the comparing.

### CROSS-REFERENCE TO RELATED APPLICATION

This application is based upon and claims the benefit of priority of the prior Japanese Patent Application No. 2011-67484, filed on Mar. 25, 2011, the entire contents of which are incorporated herein by reference.

### FIELD

The embodiments discussed herein are related to a method for managing a virtual machine, an information-processing apparatus, and a medium for a virtual machine management program.

### BACKGROUND

Virtualization technology for operating one or more information processing apparatuses (which may be called “virtual machines”) on a physical information processing apparatus (which may be called a “physical machine”) has been put to use. Various settings may be performed on each virtual machine independently from other virtual machines. For example, an operating system (OS) and application software may be installed on each virtual machine. Programs and data of a user may also be allotted to each virtual machine. System-setting information, such as a host name and address, may also be given to each virtual machine.

A set of files used for operation of one virtual machine may be managed as a file system that is independent from those of other virtual machines. The file system of the virtual machine is updated according to, for example, changes in the settings of the virtual machine. The file system of the virtual machine may also be stored in a nonvolatile storage device. In such a case, the virtual machine may be restarted using the stored file system. When the file system of the virtual machine is treated as a batch of data, the batch of data may also be called a “virtual machine image”. Through movement or replication of the virtual machine image, the virtual machine may be started on an arbitrary information processing apparatus.

Several techniques have been proposed in order to manage a virtual machine. For example, in comparison with a first virtual machine and a second virtual machine, files contained in both of the first and second virtual machine images are detected and the common files are shared between the first and second virtual machine images. Furthermore, a restoration system in which, when a new configuration management profile is applied to objects that are functions of communication equipment, differences between working objects and a new object are pre-stored. And when a failure occurs, the objects are restored on the basis of the differences.

There are also cases in which multiple virtual machines having different settings are created, files used for operations of the virtual machines are stored, and the virtual machines are selectively used. For example, during testing of software, programs and data to be allotted, communication settings, and so on may be varied depending on the virtual machine to perform multiple types of testing or to perform testing in distributed processing operations.

However, when virtual machines having different settings are created, there is a problem in that the management of the virtual machines may become complicated. For example, when it is desired to select and start, out of created virtual machines, one virtual machine on which a desired setting has been performed, there is a problem with how to check the settings.

Examples of related art are discussed in International Publication Pamphlet No. WO 2007/080044 and Japanese Laid-open Patent Publication No. 2006-309413.

### SUMMARY

According to an aspect of the invention, a method of managing a virtual machine by an information processing system including one or more information processing apparatuses, the method includes: comparing one or more files used for operation of the virtual machine with one or more template files; and generating configuration information indicating a setting state of the virtual machine based on a result of the comparing.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an information processing apparatus according to a first embodiment;

FIG. 2 is a diagram illustrating an information processing system according to a second embodiment;

FIG. 3 is a block diagram illustrating an example of hardware of a server apparatus;

FIG. 4 illustrates one example of differences between a VM image and a VM image template;

FIG. 5 is a block diagram illustrating an example of software of the server apparatus;

FIG. 6 illustrates an example of an extraction-condition table;

FIG. 7 illustrates an example of a disregard-condition table;

FIG. 8 is a method illustrating processing for generating configuration information;

FIG. 9 illustrates an example of a directory structure of the VM image;

FIG. 10 illustrates an example of system-setting information of a virtual machine;

FIG. 11 illustrates an example of a result of extraction of differences between a VM image and a VM image template;

FIG. 12 illustrates an example of the configuration information of the virtual machine;

FIG. 13 is a method illustrating processing for starting the virtual machine;

FIG. 14 illustrates an example of a method for storing the VM images;

FIG. 15 illustrates an example of a sequence of managing the virtual machines;

FIG. 16 illustrates an example of a management screen of the virtual machines; and

FIG. 17 illustrates an example of a management screen of the virtual machines (subsequent).

### DESCRIPTION OF EMBODIMENTS

Embodiments of the present technology will be described below with reference to the accompanying drawings.

### First Embodiment

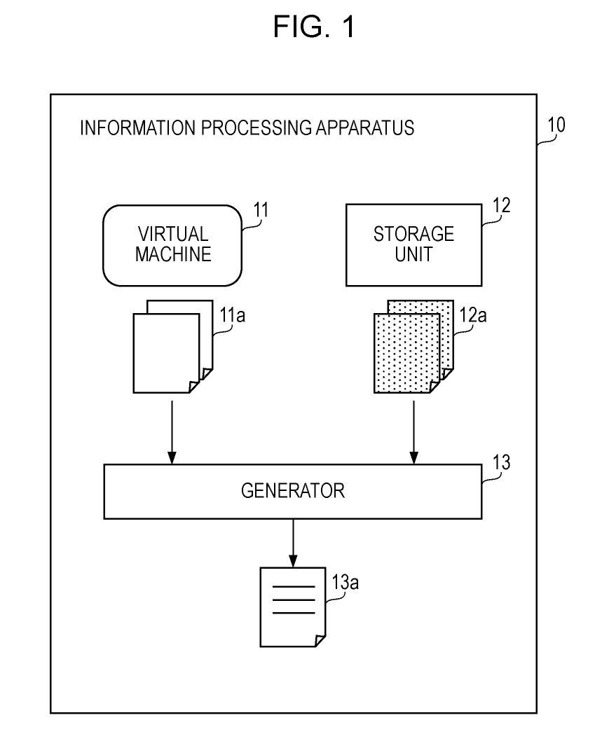

FIG. 1 is a diagram illustrating an information processing apparatus according to a first embodiment. An information processing apparatus 10 according to a first embodiment is used in an information processing system including one or more information processing apparatuses on which a virtual machine is operable. A virtual machine 11 operates in the information processing apparatus 10 or another information processing apparatus connected to the information processing apparatus 10 through a network.

The information processing apparatus 10 has a generator 13. The generator 13 may be implemented as a program executed by using a CPU (central processing unit) and a RAM (random access memory), and may also be implemented as a virtual machine. The generator 13 compares one or more files 11a used for operation of the virtual machine 11 with one or more template files 12a stored in a storage unit 12. On the basis of a result of the comparison, the generator 13 generates configuration information 13a indicating setting states of the virtual machine 11.

Examples of the files 11a include files contained in a file system managed by an OS (operating system) of the virtual machine 11. The files 11a may include setting files in which system-setting information such as a host name is written, files of application software, and files of programs and data created by a user. The storage unit 12 may be provided in the information processing apparatus 10 or may be a storage device included in another information processing apparatus connected with the information processing apparatus 10 through a network. The template files 12a are, for example, initial files, i.e., files to which the user has not made any changes and has not performed any editing.

The information processing apparatus 10 may generate the template files 12a during generation of the configuration information 13a. For example, the information processing apparatus 10 may generate the template files 12a by checking software (e.g., the OS and application software) installed on the virtual machine 11 and retrieving installation files, used for installation of the checked software, from a predetermined storage device. Generation of the template files 12a may be performed by the generator 13 or a module other than the generator 13. Generation of the template files 12a may also be performed by an information processing apparatus other than the information processing apparatus 10.

The configuration information 13a may be generated based on differences between one or more files 11a and one or more template files 12a. For example, the generator 13 may extract the differences, select any of the differences which satisfies a predetermined condition, and insert the selected difference into the configuration information 13a. The selected difference may contain the system-setting information written in the setting files. The generator 13 may extract a file that is contained in the set of files 11a and is not contained in the set of template files 12a, generate a package file that is unique to the virtual machine 11, and insert information indicating the package file into the configuration information 13a.

The generated configuration information 13a may also be stored in a nonvolatile storage device. The configuration information 13a may be used in order to search for, of virtual machines that are operable in the information processing system, a virtual machine to be started. The configuration information 13a may also be used to start the virtual machine 11. For example, the information processing apparatus 10 or another information processing apparatus may restore the virtual machine 11 by applying information (e.g., the system-setting information, such as the host name) contained in the configuration information 13a, to the template files 12a.

The information processing apparatus 10 according to the first embodiment compares one or more files 11a, used for operation of the virtual machine 11, with one or more template files 12a. On the basis of a result of the comparison, the information processing apparatus 10 generates the configuration information 13a indicating the setting states of the virtual machine 11. This makes it easy to manage the virtual machine 11.

For example, even when virtual machines having different settings are created, the present technology makes it easy to search for a desired one of the virtual machines. Before starting the virtual machine 11, it is also possible to check the settings of the virtual machine 11. Since the configuration information 13a is generated through the comparison with the template files 12a, the user does not have to manually input and manage information relevant to the configuration information 13a. As a result, the amount load of management of the virtual machines is reduced.

### Second Embodiment

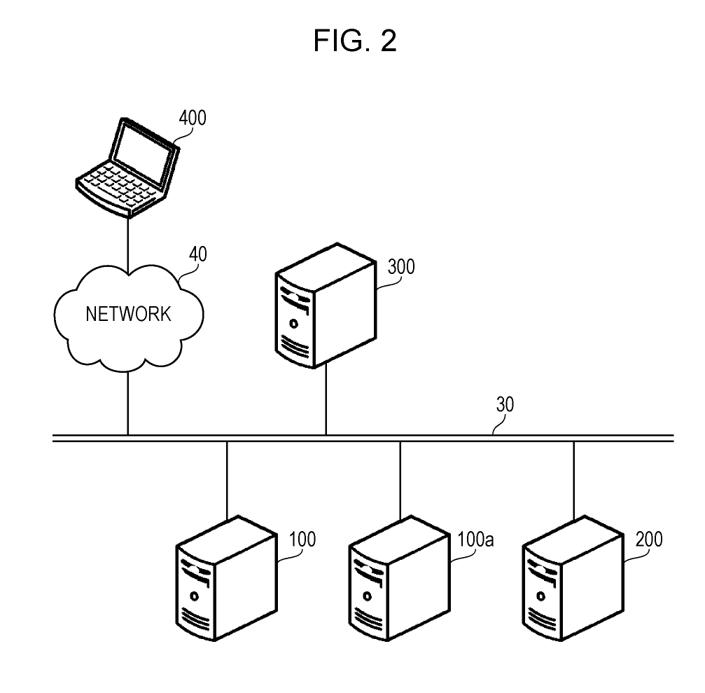

FIG. 2 is an information processing system according to a second embodiment. The information processing system according to the second embodiment includes server apparatuses 100 and 100a, a storage apparatus 200, a management apparatus 300, and a terminal apparatus 400. The server apparatuses 100 and 100a, the storage apparatus 200, and the management apparatus 300 are connected through a network 30. The terminal apparatus 400 is connected to a network 40. The information processing system according to the second embodiment may be implemented as a system having cloud-computing functionary (i.e., a cloud system).

Each of the server apparatuses 100 and 100a may be a server computer on which one or more virtual machines may be deployed. Each of the server apparatuses 100 and 100a starts or stops the virtual machines in accordance with an instruction from the management apparatus 300. A hypervisor, which is software for controlling the virtual machines, is running on each of the server apparatuses 100 and 100a. The hypervisor allocates resources of a CPU, a RAM, and so on to the virtual machines.

The storage apparatus 200 may be a computer for managing data regarding the virtual machines. The storage apparatus 200 has a common repository, a unique repository, and a configuration-information database. The common repository stores files of software, such as OSs and package applications, usable by multiple users. The unique repository stores user-specific files, such as programs and data created by each user. The configuration information database stores pieces of configuration information of the virtual machines. Each piece of configuration information contains the system-setting information, such as the host name, and information indicating the installed software.

The management apparatus 300 is a computer for managing the deployment of the virtual machines onto the server apparatuses 100 and 100a. When the terminal apparatus 400 issues a request for starting a user's virtual machine to the management apparatus 300, the management apparatus 300 selects one of the server apparatuses 100 and 100a so that the amount of load is not concentrated on one of the server apparatuses 100 and 100a, and causes the user's virtual machine to be started on the selected server apparatus 100 or 100a. When the terminal apparatus 400 issues a request for generating configuration information for the user's virtual machine to the management apparatus 300, the management apparatus 300 causes a virtual machine having a configuration-information-generating function to operate on one of the server apparatuses 100 and 100a (preferably, on the server apparatus on which the user's virtual machine is operating, when it is already operating).

The terminal apparatus 400 may be a computer serving as a client apparatus operated by the user. The terminal apparatus 400 may access the network 30 through the network 40 to request the management apparatus 300 so as to start the user's virtual machine. The terminal apparatus 400 may also request the management apparatus 300 so as to generate configuration information for the user's virtual machine. The generated configuration information may be used, for example, in order to select a virtual machine to be started. A web browser may also run on the terminal apparatus 400 as a user interface used for access.

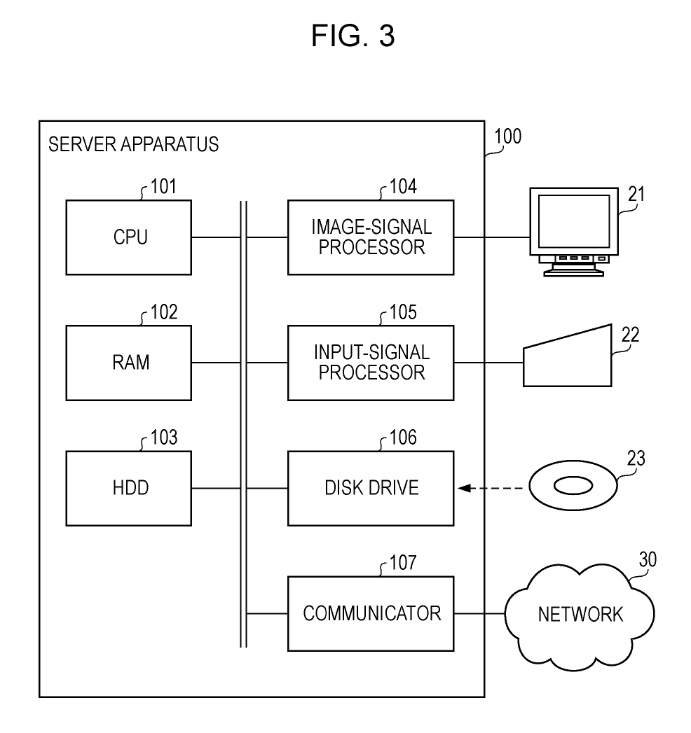

FIG. 3 is a block diagram illustrating an example of hardware of the server apparatus. The server apparatus 100 includes a CPU 101, a RAM 102, a HDD (hard disk drive) 103, an image-signal processor 104, an input-signal processor 105, a disk drive 106, and a communicator 107. Those pieces of hardware are connected to a bus in the server apparatus 100. The server apparatus 100a, the storage apparatus 200, the management apparatus 300, and the terminal apparatus 400 may also be realized by pieces of hardware that are similar to those of the server apparatus 100.

The CPU 101 is a computing device for controlling information processing of the server apparatus 100. The CPU 101 reads at least part of programs and data stored in the HDD 103 or a storage device of another computer (e.g., the storage apparatus 200), loads the read programs and/or data into the RAM 102, and executes the programs. The server apparatus 100 may have multiple computing devices to execute information processing in a distributed manner.

The RAM 102 is a volatile memory that temporarily stores a program and data processed by the CPU 101. The server apparatus 100 may have a memory other than the RAM type and may also have multiple memories.

The HDD 103 is a nonvolatile storage device that stores programs, such as an OS program and application programs, and data used for information processing. In accordance with an instruction from the CPU 101, the HDD 103 performs writing to or reading from built-in magnetic disks. Part of the storage area of the HDD 103 may be allocated to the virtual machine as a virtual disk. The server apparatus 100 may have a nonvolatile storage device (e.g., an SSD (solid state drive)), other than the HDD type, and may also have multiple storage devices.

In accordance with an instruction from the CPU 101, the image-signal processor 104 outputs an image onto a display 21 connected to the server apparatus 100. Examples of the display 21 include a CRT (cathode ray tube) display and a liquid crystal display.

The input-signal processor 105 obtains an input signal from an input device 22, connected to the server apparatus 100, and outputs the obtained input signal to the CPU 101. Examples of the input device 22 include pointing devices, such as a mouse and a touch panel, and a keyboard.

The disk drive 106 is a driving device for reading a program and data recorded on a recording medium 23. Examples of the recording medium 23 include a magnetic disk such as a flexible disk (FD) or a HDD, an optical disc such as a CD (compact disc) or a DVD (digital versatile disc), or a magneto-optical disk (MO). For example, in accordance with an instruction from the CPU 101, the disk drive 106 stores the program and data, read from the recording medium 23, into the RAM 102 or the HDD 103.

The communicator 107 is a communication interface for connection and communication with the network 30. The connection to the network 30 may performed in a wired or wireless manner. That is, the communicator 107 may be a wired communication interface or a wireless communication interface.

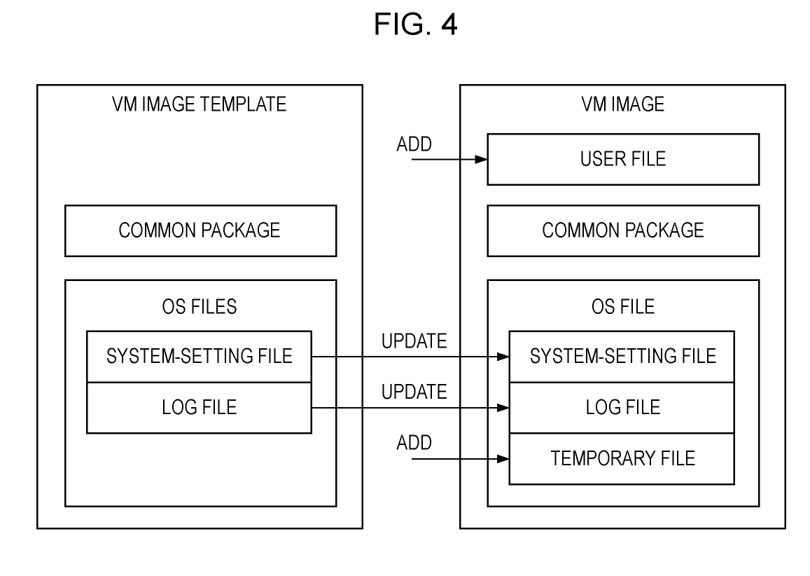

FIG. 4 illustrates one example of differences between a virtual machine (VM) image and a VM image template. The VM image template is a reference VM image to be compared with the current VM image of the user's virtual machine in order to generate the configuration information. The VM image template corresponds to, for example, a VM image generated immediately after a virtual machine is created through the user's designation of an OS and package applications. The VM image is updated in accordance with operation of the virtual machine.

The VM image template contains, for example, the OS files and the common package. The OS files are used for operation of the OS and include a system-setting file and a log file. A default value of the system setting information is written in the system-setting file in the VM image template. The log file may be blank. The common package contains files used for operation of the package applications (such as, database management software) usable by the multiple virtual machines.

The VM image of the virtual machine after it is started contains, for example, OS files, a common package, and user files. The OS files include a system-setting file, a log file, and a temporary file (which may be referred to as a “tmp file”). System-setting information modified by the user is written in the system-setting file in the current VM image. Log information indicating a use state of the virtual machine is written in the log file. The temporary file is a file temporarily generated in conjunction with operation of the OS. The user files include programs and data created by the user.

Comparison of the current VM image of the virtual machine with the VM image template may indicate that a user file is added to the VM image, the system-setting file and the log file of the OS are updated, and a temporary file of the OS is added to the VM image, as in the case illustrated in FIG. 4. Of such differences, the difference between the user file and the system-setting file is particularly useful in order to recognize the use state of the virtual machine.

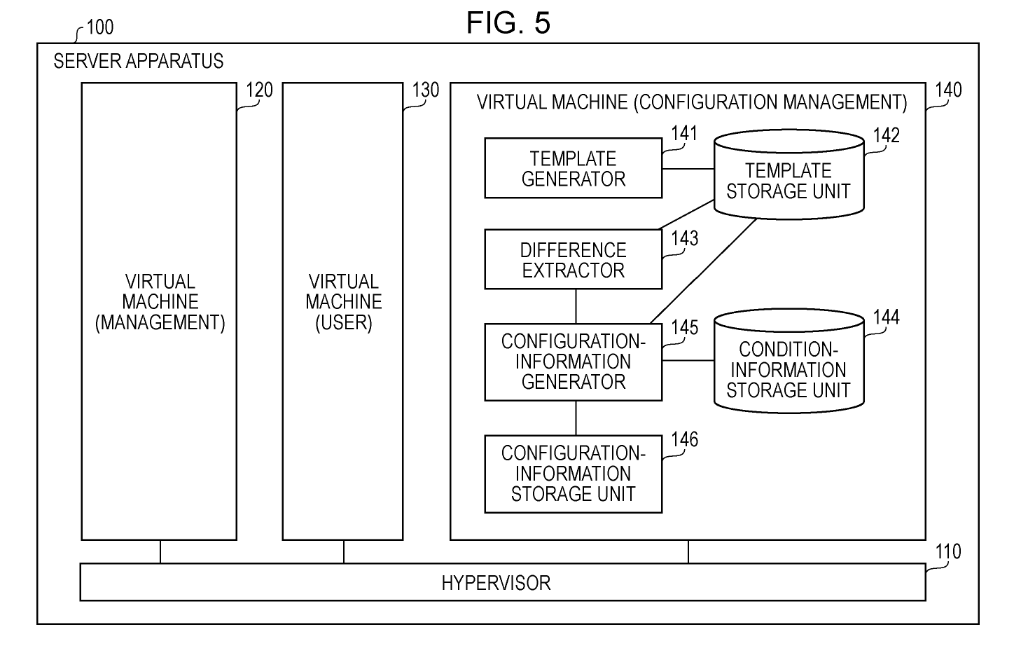

FIG. 5 is a block diagram illustrating an example of software of the server apparatus. On the server apparatus 100, a hypervisor 110 and virtual machines 120, 130, and 140 are operable. On the server apparatus 100a, pieces of software that are similar to those of the server apparatus 100 are also operable.

The hypervisor 110 controls virtual machines including the virtual machines 120, 130, and 140. The hypervisor 110 allocates resources, such as a processing capability of the CPU 101, storage areas of the RAM 102 and the HDD 103, and a communication band of the communicator 107, to the virtual machines 120, 130, and 140. The hypervisor 110 also relays access from the virtual machines 120, 130, and 140 to the devices and access among the virtual machines 120, 130, and 140.

In this example, the virtual machine 120 serves as a management virtual machine to control start and stop of the virtual machines including the virtual machines 130 and 140. When an instruction for starting the user's virtual machine is issued from the management apparatus 300, the virtual machine 120 retrieves files for the user's virtual machine from the storage apparatus 200, loads the files into the storage area (the virtual disk) allocated on the HDD 103, and starts the user's virtual machine. When an instruction for stopping the user's virtual machine is issued from the management apparatus 300, the virtual machine 120 also stops the user's virtual machine. Also, when an instruction for generating configuration information is issued from the management apparatus 300 to the virtual machine 120, it starts the virtual machine 140 as the same with the case of the user's virtual machine.

The virtual machine 130 is the user's virtual machine that is started and stopped under the control of the virtual machine 120. In accordance with an instruction from the terminal apparatus 400, the virtual machine 130 may also update the files on the virtual disk. In conjunction with execution of an application program or a program created by the user, the virtual machine 130 may also update the files on the virtual disk.

The virtual machine 140 serves as a configuration-management virtual machine to generate configuration information for the user's virtual machine, such as the virtual machine 130. On the basis of an instruction from the management apparatus 300, the virtual machine 140 is started under the control of the virtual machine 120. A case in which the virtual machine 140 generates the configuration information of the virtual machine 130 will be discussed in the following description of the second embodiment. The virtual machine 140 includes a template generator 141, a template storage unit 142, a difference extractor 143, a condition-information storage unit 144, a configuration-information generator 145, and a configuration-information storage unit 146.

The template generator 141 generates a VM image template and a configuration information template for the virtual machine 130. More specifically, the template generator 141 generates a VM image template by checking the OS and the package applications installed on the virtual machine 130 and retrieving, from the storage apparatus 200, the OS files and the common package for the OS and the package applications. The template generator 141 also generates the configuration information template in which default information corresponding to the installed OS and package applications is written.

The template storage unit 142 stores the VM image template and the configuration information template generated by the template generator 141. The template storage unit 142 may be realized as a storage area of the virtual disk. Without generating the template, the template generator 141 may also request the virtual machine 120 to generate the template. Before starting the virtual machine 140, the virtual machine 120 may also generate the template.

In order to compare the VM image of the virtual machine 130 with the VM image template, the difference extractor 143 mounts the VM image of the virtual machine 130 and the VM image template, stored in the template storage unit 142, onto the file system of the virtual machine 140. The difference extractor 143 compares the VM image of the virtual machine 130 with the VM image template, stored in the template storage unit 142, to extract differences thereby. For example, the difference extractor 143 compares the VM image file of the virtual machine 130 with the VM image template to extract a file (e.g., the user file) added to the VM image or an updated file (e.g., the system-setting file) of the virtual machine 130.

The condition-information storage unit 144 stores condition information indicating a condition for selecting a difference associated with the configuration information from differences extracted by the difference extractor 143. The condition-information storage unit 144 may be realized as, for example, a storage area reserved in the RAM 102 or the HDD 103. The condition indicated by the condition information includes an extraction condition and a disregard condition. The extraction condition indicates a file from which information of a specific item (e.g., the host name included in the system-setting information) is to be extracted. The disregard condition indicates a file to be disregarded, since it is not associated with the configuration information.

The configuration-information generator 145 generates the configuration information and the unique package of the virtual machine 130 based on the differences extracted by the difference extractor 143 and the condition information stored in the condition-information storage unit 144. More specifically, the configuration-information generator 145 generates the configuration information, for example, by extracting information of a specific item from a file that matches the extraction condition and modifying the configuration information template stored in the template storage unit 142. The configuration-information generator 145 also generates the unique package by combining files that do not match either the extraction condition or the disregard condition. The configuration-information generator 145 then inserts identification information of the unique package into the configuration information.

The configuration-information storage unit 146 stores, in the configuration information database in the storage apparatus 200, the configuration information generated by the configuration-information generator 145. The configuration-information storage unit 146 also stores, in the unique repository in the storage apparatus 200, the unique package generated by the configuration-information generator 145.

Although an example in which the configuration information of the virtual machine 130 is generated by the virtual machine 140 has been described above in the second embodiment, the configuration information of the virtual machine 130 may be generated by software other than the virtual machine. The virtual machine 140 may operate on a server apparatus that is different from the server apparatus on which the virtual machine 130 operates. Upon detecting that the OS of the virtual machine 130 is shut down, the virtual machine 140 may automatically start up to generate the configuration information of the virtual machine 130.

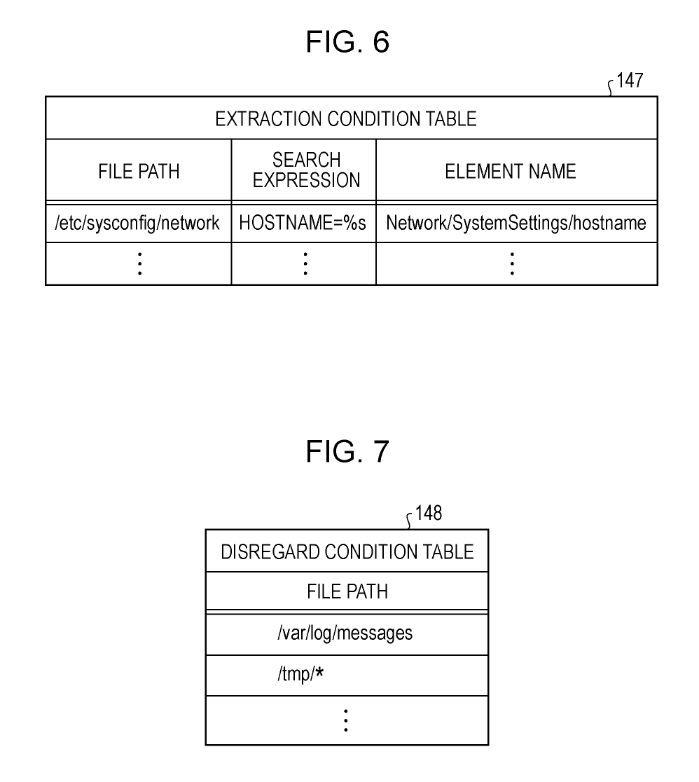

FIG. 6 illustrates an example of an extraction condition table. An extraction condition table 147 is stored in the condition-information storage unit 144. The extraction condition table 147 may be prepared for each type of OS. The extraction condition table 147 contains file paths, search expressions, and element names.

Each file path indicates the location of a file in the file system. For example, the file path specifies the system-setting file. Each search expression indicates a character string to be searched for from the file indicated by the corresponding file path. The search expression may be a regular expression and may include a variable (% s). For example, a character string stating a host name is specified as a search target. Each element name indicates, in the configuration information, a location into which information corresponding to a character string that matches the search expression (e.g., a character string corresponding to a variable % s) is to be inserted. When the character string that matches the search expression is updated from the corresponding character string in the VM image template, information is inserted into the location contained in the configuration information and indicated by the element name.

FIG. 7 illustrates an example of a disregard condition table. A disregard condition table 148 is stored in the condition-information storage unit 144. The disregard condition table 148 may be prepared for each type of OS. The disregard condition table 148 contains file paths. Each file path indicates the location of a file to be disregarded when addition or update is performed thereto (i.e., the location of a file to be excluded from the unique package). The file path may have a wild card (*) or may specify a directory. For example, the file path may specify a log file or a temporary file.

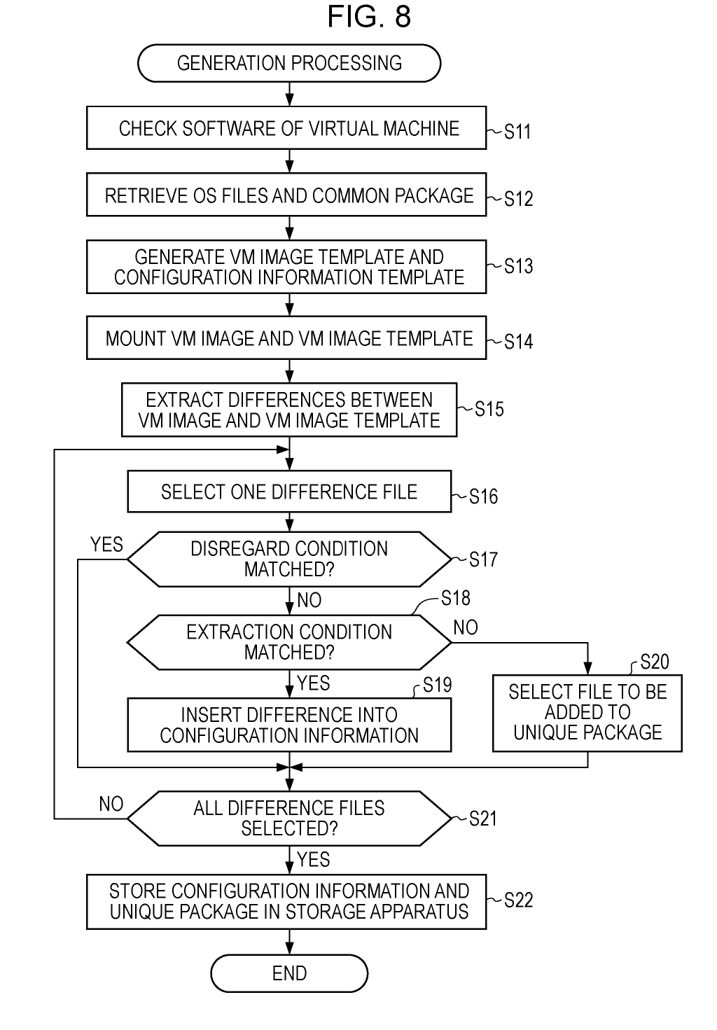

FIG. 8 is a method illustrating processing for generating the configuration information. The generation processing illustrated in FIG. 8 will now be described along with step numbers.

In step S11, the template generator 141 checks the OS and the package applications installed on the virtual machine 130. In this case, the template generator 141 may check the OS, for example, by referring to attribute information of the VM image of the virtual machine 130. Alternatively, when the user operates the terminal apparatus 400 to give an instruction for generating the configuration information, the user may be prompted to input information indicating the OS. The template generator 141 may also check the package applications, for example, by transmitting a command (e.g., an rpm command) of package management commands to the virtual machine 130 and obtaining a list of package applications from the virtual machine 130.

In step S12, the template generator 141 retrieves, from the common repository in the storage apparatus 200, the OS files and the common package which respectively correspond to the OS and the package applications checked in step S11.

A file of combination of OS files and a common package which are often used may also be stored in the common repository in the storage apparatus 200. For example, the VM image template of a virtual machine on which an OS and package applications which are often used are installed may be stored in the common repository in the storage apparatus 200. In such a case, the template generator 141 may retrieve, from the common repository in the storage apparatus 200, a file corresponding to the combination of the OS and the package applications checked in step S11.

In step S13, the template generator 141 loads the OS files, obtained in step S12, into the template storage unit 142 and further loads the common package into the template storage unit 142 (e.g., performs installation processing) to thereby generate a VM image template. The template generator 141 also generates a configuration information template on the basis of the result of the OS and package-applications checking performed in step S11. The generation of the VM image template may also be performed by the virtual machine 120.

In step S14, the difference extractor 143 mounts the current VM image of the virtual machine 130 and the VM image template generated in step S13 onto the file system of the virtual machine 140. As a result, the virtual machine 140 may access the files used by the virtual machine 130 and the files contained in the VM image template, by tracing the directory structure of the file system of the virtual machine 140.

In step S15, the difference extractor 143 compares the set of files used by the virtual machine 130 with the set of files contained in the VM image template, including those in the directory structure, to extract differences between the sets of files. For example, an rsync command, a diff command, a find command, a test command, and so on may be used to compare the sets of files. The extracted differences include a file included in either one of the sets of files and a file included in both of the sets of files but with the contents thereof being different from each other. With respect to the files with the different contents, the difference extractor 143 detects character strings of updated portions in the files.

In step S16, the configuration-information generator 145 selects one of the files that are used by the virtual machine 130 and that are the differences extracted in step S15.

In step S17, the configuration-information generator 145 checks the path of the file, selected in step S16, to determine whether or not the path of the file matches the disregard condition in the disregard condition table 148 (i.e., whether or not the path of the file is registered in the disregard condition table 148). When the path of the file matches the disregard condition, the process proceeds to step S21. When the path of the file does not match the disregard condition, the process proceeds to step S18.

In step S18, the configuration-information generator 145 determines whether or not the path of the file selected in step S16 matches the extraction condition in the extraction condition table 147 (i.e., whether or not the path of the file is registered in the extraction condition table 147). When the path of the file matches the extraction condition, the process proceeds to step S19. When the file of the path does not match the extraction condition, the process proceeds to step S20.

In step S19, the configuration-information generator 145 checks a character string of an updated portion in the file selected in step S16 against the search expressions in the extraction condition table 147 to extract a character string to be written to the configuration information. The configuration-information generator 145 then inserts the extracted character string into the location included in the configuration information template generated in step S13 and indicated by the element name in the extraction condition table 147. Thereafter, the process proceeds to step S21.

In step S20, the configuration-information generator 145 selects the file, selected in step S16, as a file to be added to a unique package.

In step S21, the configuration-information generator 145 determines whether or not all of the files that are used by the virtual machine 13 and that are the differences extracted in step S15 have been selected. When all of the files are selected, the process proceeds to step S22. When any unselected file remains, the process returns to step S16.

In step S22, the configuration-information generator 145 generates a unique package including one or more files selected in step S20. The configuration-information generator 145 also inserts the name of the unique package into the configuration information created in step S19 based on the configuration information template. The configuration-information storage unit 146 stores the generated configuration information in the configuration information database in the storage apparatus 200 through the network 30. The configuration-information storage unit 146 also stores the generated unique package in the unique repository in the storage apparatus 200 through the network 30.

The name of the unique package may be input by the user through operation of the terminal apparatus 400 or may be automatically given by the configuration-information generator 145. The unique package may also be generated, for example, by specifying a file to be included in the unique package and issuing an rpmbuild command.

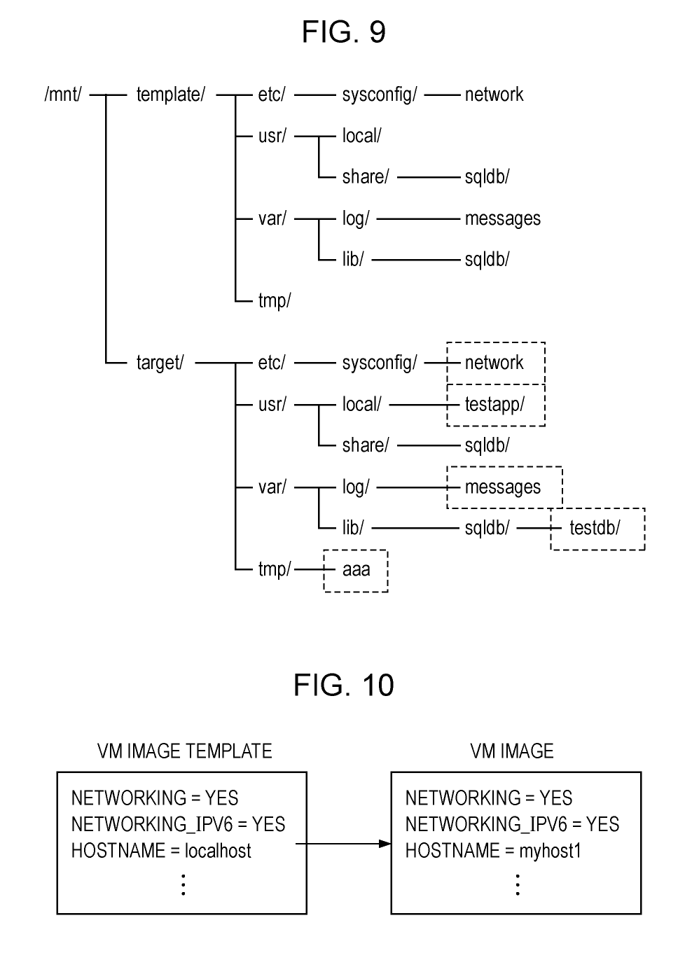

FIG. 9 illustrates an example of the directory structure of the VM image. When the VM image of the virtual machine 130 is mounted on the virtual machine 140, for example, a directory “target” is generated below a directory “mnt” of the virtual machine 140. When the VM image template is mounted on the virtual machine 140, for example, a directory “template” is generated below the directory “mnt” of the virtual machine 140.

The file system of the virtual machine 130 includes a system-setting file “network”, a user directory “testapp/”, a log file “messages”, a user directory “testdb/”, and a temporary file “aaa”. In this case, it is assumed that the contents of the system-setting file and the log file are different from the contents of the VM image template (i.e., are updated). It is also assumed that the temporary file “aaa” and the two user directories “testapp/” and “testdb/” do not exist in the VM image template.

FIG. 10 illustrates an example of the system-setting information of the virtual machine. Pieces of system-setting information of items including a host name (“HOSTNAME”) are written in the system-setting file “network”. For example, a default host name “localhost” is written in the system-setting file contained in the VM image template. For example, a host name “myhost1” updated by the user is written in the system-setting file contained in the VM image of the virtual machine 130.

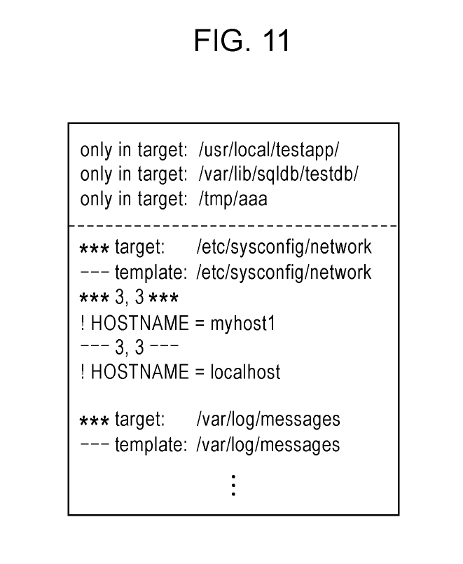

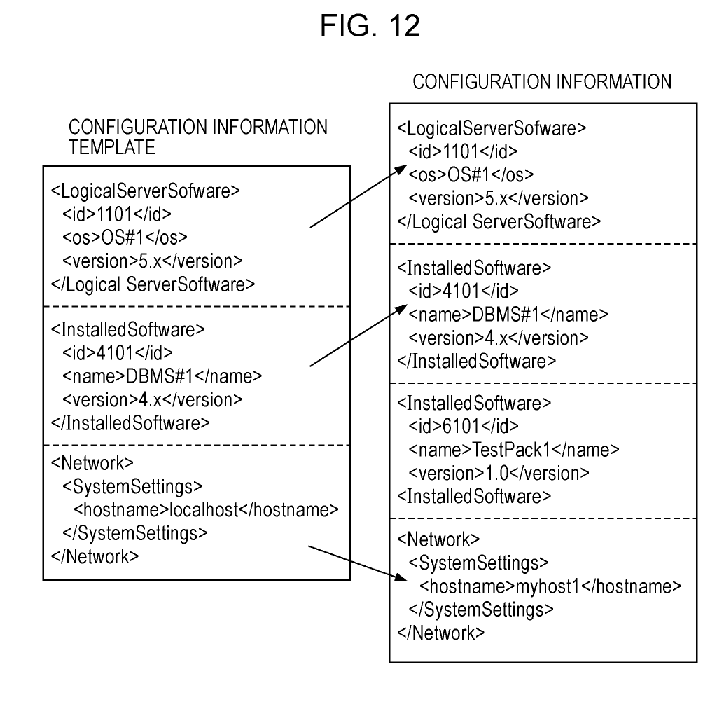

FIG. 11 illustrates an example of an extraction result of differences between the VM image and the VM image template. Upon performing the difference extraction on the file system illustrated in FIG. 9, the difference extractor 143 generates a difference-extraction result as illustrated in FIG. 11 and outputs the difference-extraction result to the configuration-information generator 145.

This difference extraction result indicates that the directory “testapp/”, the directory “testdb/”, and the file “aaa” are contained in the VM image of the virtual machine 130 and are not contained in the VM image template. The difference extraction result also indicates that the contents of the files “network” and “messages” are different between the VM image of the virtual machine 130 and the VM image template. The difference extraction result further indicates that “HOSTNAME=myhost1” is written in the third row in the file “network” in the virtual machine 130 and “HOSTNAME=localhost” is written in the third row of the file name “network” in the VM image template.

The configuration-information generator 145 checks each of the differences, extracted by the difference extractor 143, against the pieces of condition information registered in the extraction condition table 147 and the disregard condition table 148. Since the files “aaa” and “messages” match the file paths registered in the disregard condition table 148, they are disregarded during generation of the configuration information. In this case, since the file “network” matches the file path registered in the extraction condition table 147, the character string “myhost1” corresponding to a variable in the search expression is extracted as the configuration information. Further, since the directories “testapp/” and “testdb/” and files and directories included in the directories “testapp/” and “testdb/” do not match any of the pieces of condition information in the extraction condition table 147 and the disregard condition table 148, they are inserted into the unique package.

FIG. 12 illustrates an example of the configuration information of the virtual machine. The configuration information may be written using, for example, the XML (Extensible Markup Language). In accordance with the OS and the package applications installed on the virtual machine 130, the template generator 141 generates a configuration information template as illustrated in FIG. 12. On the basis of the configuration information template, the configuration-information generator 145 generates configuration information as illustrated in FIG. 12.

The configuration information template contains, for example, information indicating the OS installed on the virtual machine 130, information indicating the package application(s) installed on the virtual machine 130, and the default system-setting information. The information indicating the OS includes, for example, the name and the version number of the OS. The information indicating the package applications includes, for example, the name and the version number of the package applications. The default system-setting information includes, foe example, the host name written in the system-setting file in the VM image template.

The configuration information includes, for example, information indicating the OS installed on the virtual machine 130, information indicating the package applications installed on the virtual machine 130, information indicating the unique package for the virtual machine 130, and the system-setting information. The information included in the configuration information template may be used as the information indicating the OS and the information indicating the package applications. The system-setting information includes, for example, the host name extracted from the system-setting file. The information indicating the unique package includes the name of the unique package generated by the configuration-information generator 145 (e.g., the name input by the user).

The configuration information generated by the virtual machine 140 and stored in the storage apparatus 200 may be used for the user to select the virtual machine to be started. The configuration information may also be used to start the virtual machine 130.

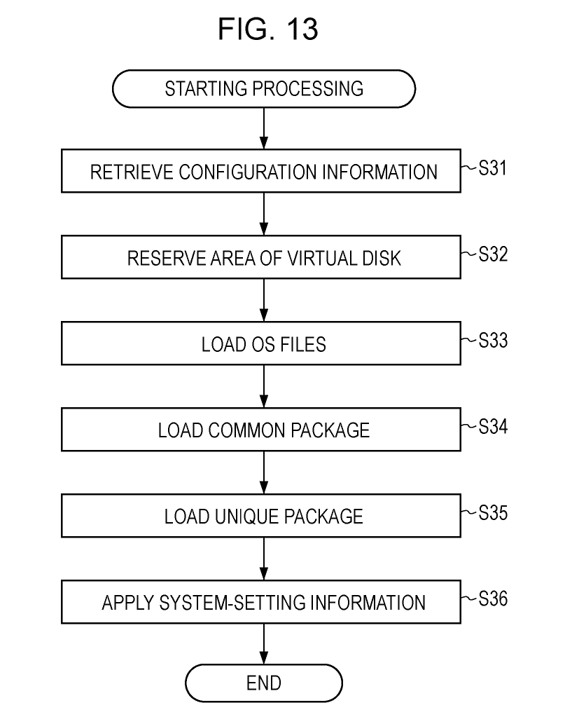

FIG. 13 is a method illustrating processing for starting the virtual machine. An example in which the virtual machine 130 is started will now be described with reference to the start processing in FIG. 13 along with step numbers.

In step S31, when an instruction for starting the user's virtual machine 130 is issued from the management apparatus 300 to the virtual machine 120, the virtual machine 120 retrieves the configuration information of the virtual machine 130 from the configuration information database in the storage apparatus 200 through the network 30.

In step S32, the hypervisor 110 reserves an area of the virtual disk on the HDD 103 and allocates the reserved area to the virtual machine 130.

In step S33, the virtual machine 120 refers to the configuration information of the virtual machine 130, the configuration information being retrieved in step S31, to check the OS used by the virtual machine 130 and retrieves corresponding OS files from the common repository in the storage apparatus 200. The virtual machine 120 then loads the OS files onto the virtual disk allocated to the virtual machine 130.

In step S34, the virtual machine 120 refers to the configuration information of the virtual machine 130 to check the package applications used by the virtual machine 130 and retrieves the common package from the common repository in the storage apparatus 200. The virtual machine 120 then loads the common package onto the virtual disk allocated to the virtual machine 130.

In step S35, the virtual machine 120 refers to the configuration information of the virtual machine 130 to retrieve, from the unique repository in the storage apparatus 200, the unique package for the virtual machine 130. The virtual machine 120 then loads the unique package onto the virtual disk allocated to the virtual machine 130.

In step S36, the virtual machine 120 applies the system-setting information, written in the configuration information of the virtual machine 130, to the OS of the virtual machine 130. For example, the virtual machine 120 uses the system-setting information, written in the configuration information, to update the system-setting file of the OS. Thereafter, the hypervisor 110 boots the OS of the virtual machine 130.

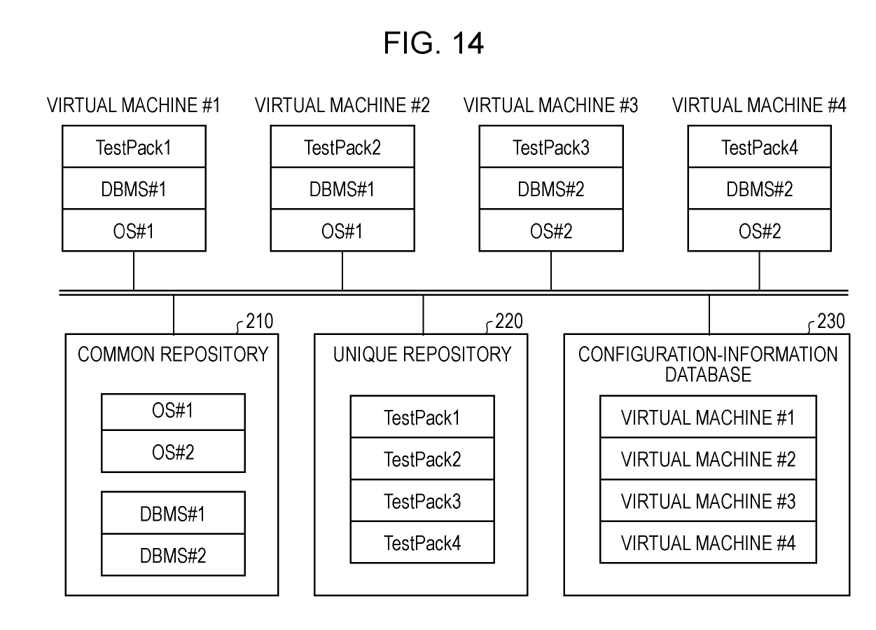

FIG. 14 illustrates an example of a method for storing VM images. In this case, a description is given of a case in which the user who operates the terminal apparatus 400 creates four virtual machines (i.e., virtual machines #1 to #4). Each of the virtual machines #1 and #2 uses an OS #1 as the OS and also uses a DBMS (database management system) #1 as a package application. Each of the virtual machines #3 and #4 uses an OS #2 and a DBMS #2.

The storage apparatus 200 has a common repository 210, a unique repository 220, and a configuration-information database 230. Files of the OSs #1 and #2 and packages of the DBMSs #1 and #2 are stored in the common repository 210. Unique packages (i.e., TestPack1 to TestPack4) for the respective virtual machines #1 to #4 are stored in the unique repository 220. Pieces of configuration information for the virtual machines #1 to #4 are contained in the configuration-information database 230.

As in the case of this example, the VM images of the virtual machines #1 to #4 may be stored in the OS files, the common package, and the unique package in a divided manner. This arrangement may save the storage area, compared to a case in which the VM images of the virtual machines #1 to #4 are stored without division of the VM images. This arrangement also makes it possible to restore an arbitrary one of the virtual machines #1 to #4 by referring to the configuration information and using the OS files, the common package, and the unique package.

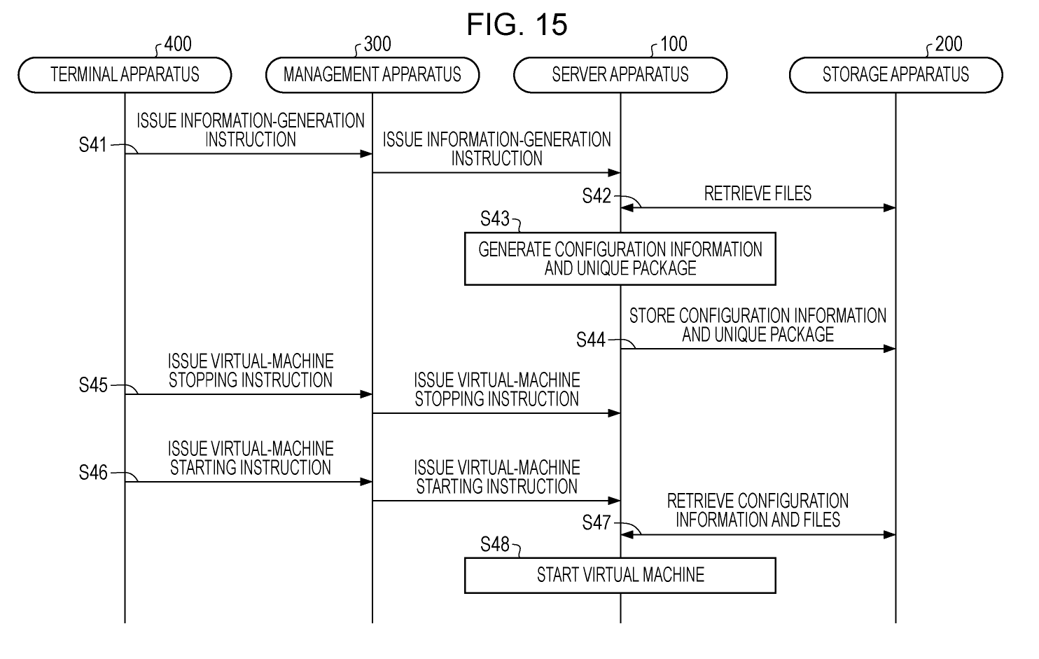

FIG. 15 illustrates an example of a sequence of managing the virtual machine. In this case, a description will be given of a case in which the configuration information of the virtual machine 130 is generated and the virtual machine 130 is stopped and is then re-started.

In step S41, the terminal apparatus 400 instructs the management apparatus 300 to generate the configuration information of the virtual machine 130. The management apparatus 300 searches for the server apparatus 100 on which the virtual machine 130 is deployed and instructs the server apparatus 100 to generate the configuration information of the virtual machine 130.

In step S42, the server apparatus 100 retrieves, from the storage apparatus 200, files (e.g., the VM image) used for operation of the virtual machine 140 for generating the configuration information.

In step S43, the server apparatus 100 starts the virtual machine 140 to generate the configuration information and the unique package for the virtual machine 130. In this case, the server apparatus 100 accesses the storage apparatus 200 to retrieve files used for generation of a VM image template.

In step S44, the server apparatus 100 stores, in the storage apparatus 200, the generated configuration information and the unique package of the virtual machine 130.

In step S45, the terminal apparatus 400 instructs the management apparatus 300 so as to stop the virtual machine 130. The management apparatus 300 searches for the server apparatus 100 on which the virtual machine 130 is deployed and instructs the server apparatus 100 so as to stop the virtual machine 130. The server apparatus 100 instructs the OS of the virtual machine 130 to shut down.

In step S46, the terminal apparatus 400 retrieves at least part of the configuration information, stored in the storage apparatus 200, via the management apparatus 300. On the basis of the retrieved configuration information, the terminal apparatus 400 selects the virtual machine 130 as a virtual machine that the user is to start. The terminal apparatus 400 then instructs the management apparatus 300 to start the virtual machine 130. The management apparatus 300 selects, for example, the server apparatus 100, considering the amount of load, and instructs the server apparatus 100 to start the virtual machine 130.

In step S47, the server apparatus 100 retrieves the configuration information of the virtual machine 130 from the storage apparatus 200. The server apparatus 100 also retrieves, from the storage apparatus 200, the OS files, the common package, and the unique package indicated by the configuration information.

In step S48, the server apparatus 100 loads the retrieved OS files, the common package, and the unique package onto the virtual disk to restore the VM image of the virtual machine 130. The hypervisor 100 then boots the OS of the virtual machine 130.

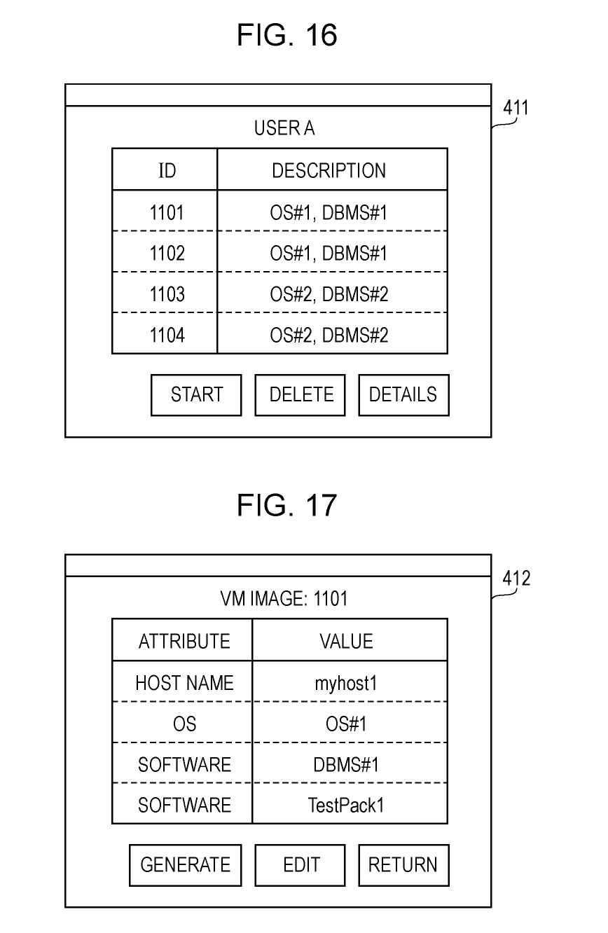

FIG. 16 illustrates an example of a management screen of virtual machines. A management screen 411 is displayed on a display of the terminal apparatus 400, for example, when the terminal apparatus 400 accesses the management apparatus 300. The management screen 411 may be realized as a screen of a web browser. A list of virtual machines created by the user is displayed on the management screen 411. For example, the management apparatus 300 generates the list of virtual machines through acquirement of the configuration information from the storage apparatus 200.

The user may check, on the management screen 411, a description of setting states of the virtual machines #1 to #4. Examples of the setting states include setting states of the OSs and package applications installed on the virtual machines #1 to #4. The user may also select one virtual machine on the management screen 411 and may give an instruction for starting or deleting the selected virtual machine. The user may also select one virtual machine on the management screen 411 so that detailed information of the selected virtual machine is displayed.

FIG. 17 illustrates an example of a (subsequent) management screen of the virtual machines. A management screen 412 is displayed on the display of the terminal apparatus 400, for example, when one virtual machine is selected on the management screen 411 and an instruction for displaying the detailed information thereof is given. The configuration information of the virtual machine selected by the user is displayed on the management screen 412. The configuration information is retrieved from, for example, the storage apparatus 200 via the management apparatus 300. When the configuration information of the virtual machine has not been generated, a “configuration information” column on the management screen 412 may be blank.

The user may instruct, on the management screen 412, the management apparatus 300 to generate (or re-generate) the configuration information. The user may also edit the configuration information on the management screen 412. For example, the user may change the host name or the version of the package application. When the user performs an operation for editing the configuration information, the terminal apparatus 400 transmits the edited information to the management apparatus 300 and the management apparatus 300 updates the configuration information stored in the storage apparatus 200. When the user changes the host name, the change of the host name takes effect in the virtual machine when it is started next time. When the user changes the version of the package application installed on the virtual machine, the package application of the changed version is launched upon start of the virtual machine next time.

According to the information processing system of the second embodiment, the configuration information of an existing virtual machine may be automatically generated from the VM image of the virtual machine. Thus, even when multiple virtual machines are created, it is possible to recognize the setting states of the respective virtual machines by referring to the automatically generated configuration information. This arrangement makes it easy to mange the multiple virtual machines. For example, referring to the configuration information makes it possible to easily select the virtual machine to be started or deleted.

This arrangement also makes it possible to combine the OS files, the common package, and the unique package to start the virtual machine, by referring to the configuration information. Accordingly, the VM images for respective the virtual machines may not be stored and thus the capacity of the storage device may be saved. Editing of the configuration information makes it possible to make changes to the virtual machine settings, such as the host name and the version number of a package application used. This reduces the amount of load of maintenance work, such application upgrading.

As described above, a virtual machine management method according to the second embodiment may be realized by causing the server apparatuses 100 or 100a having computer functionality to execute a virtual machine management program. The virtual machine management program may be recorded to a computer-readable recording medium (e.g., the recording medium 23 illustrated in FIG. 3). Examples of the recording medium include a magnetic disk, an optical disk, a magneto-optical disk, and a semiconductor memory. Examples of the magnetic disk include an FD and a HDD. Examples of the optical disk include a CD, a CD-R/RW (recordable/rewritable), a DVD, and a DVD-R/RW.

When the program is to be distributed, for example, portable recording media to which the program is recorded may be supplied. The program may also be stored in the storage device of another computer (e.g., the storage apparatus 200) and the stored program may be distributed through the network 30. For example, each of the server apparatuses 100 and 100a stores, in a storage device (e.g., the HDD 103), the program recorded to the portable recording medium or the program received from another computer, reads the program from the storage device, and executes the program. Each of the server apparatuses 100 and 100a, however, may directly execute the program read from the portable recording medium or may directly execute the program received from another computer through the network 30.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A method of managing a virtual machine by an information processing system including one or more information processing apparatuses, the method comprising:
comparing one or more files used for operation of the virtual machine with one or more template files; and
generating configuration information indicating a setting state of the virtual machine based on a result of the comparing.

2. The method according to claim 1, further comprising:
detecting software installed on the virtual machine; and
retrieving from a storage device in which files used for installation of software are stored, the file corresponding to the detected software.
generating the one or more template files based on a result of the retrieving.

3. The method according to claim 1, further comprising:
generating a package file including at least one of differences between the one or more files and the one or more template files; and
associating the generated package file with the configuration information.

4. The method according to claim 1, further comprising:
selecting, of the differences between the one or more files and the one or more template files, the difference corresponding to a condition indicated by condition information stored in a storage device; and
generating the configuration information by using the selected difference.

5. The method according to claim 1, further comprising:
storing the generated configuration information in a storage device; and
re-starting the virtual machine by using the configuration information stored in the storage device and the at least one template file.

6. An information processing apparatus comprising:
a management unit configured to manage a virtual machine operable on own information processing apparatus or another apparatus;
a storage unit configured to store one or more template files;
a comparator configured to compare one or more files used for operation of the virtual machine with the one or more template files, and
a generator configured to generate, based on a result of the comparison, configuration information indicating a setting state of the virtual machine.

7. A computer-readable, non-transitory medium storing a virtual machine management program causing a computer to execute a process, the process comprising:
comparing one or more files used for operation of the virtual machine with one or more template files; and
generating configuration information indicating a setting state of the virtual machine based on a result of the comparison.
